(19) United States
(12) Patent Application Publication
(10) Pub. No.: US 2026/0085988 A1
(43) Pub. Date: Mar. 26, 2026

(54) HIGH OUTPUT EXTENDED-RANGE STRAIN GAUGE PRESSURE SENSOR

(71) Applicant: Rosemount Inc., Shakopee, MN (US)

(72) Inventors: Nicholas E. MEYER, Victoria, MN (US); David M. STREI, Waconia, MN (US); Brian M. AFFIAS, Prior Lake, MN (US)

(21) Appl. No.: 18/895,582

(22) Filed: Sep. 25, 2024

(51) Int. Cl. G01L 19/06; G01L 1/22; G01L 1/26; G01L 7/08; G01L 9/00

(52) U.S. Cl. CPC G01L 19/0618; G01L 1/2268; G01L 1/2293; G01L 1/26; G01L 7/082; G01L 7/088; G01L 9/0042

(57) ABSTRACT

A pressure sensor includes a first wafer having a primary deflectable diaphragm and a secondary deflectable diaphragm. The primary deflectable diaphragm has a first relationship between applied pressure and deflection, and the second deflectable diaphragm has a second relationship between applied pressure and deflection. The first and second relationships differ from one another. A second wafer is attached to the first wafer. At least one tensile strain gauge is coupled to the primary deflectable diaphragm and at least one compressive strain gauge coupled to the secondary deflectable diaphragm. An overpressure feature is mounted relative to one of the first wafer and the second wafer. The overpressure feature is configured to contact the other of the first wafer and second wafer during an overpressure condition that exceeds a maximum measurement pressure of the primary deflectable diaphragm and a maximum measurement pressure of the secondary deflectable diaphragm.

### BACKGROUND

In some process control system installations, a pressure transmitter is used to monitor the pressure of a process fluid in a conduit or storage tank. The pressure transmitter includes circuitry that measures or otherwise obtains an electrical indication of a pressure sensor that is hydraulically coupled to the remote location of the pressure being monitored. The magnitude of the pressure sensor signal represents the pressure of the process fluid.

In many pressure sensors, a flexible diaphragm moves relative to a base in response to pressure applied to the top of the diaphragm. The diaphragm typically includes one or more electrical structures, such as electrodes or traces, that have an electrical characteristic, such as resistance or capacitance, that changes with the deflection of the sensing diaphragm. Diaphragms that provide repeatable monotonic movement in response to applied pressures are preferred. As a result, crystalline diaphragms, such as those made from crystalline silicon have been widely adopted since they provide monotonic movement in response to applied pressures and are generally free of hysteretic effects.

A strain gauge pressure sensor is a particular kind of pressure sensor that includes one or more conductive elements on a deformable structure of the pressure sensor. As the deformable structure deforms in response to applied pressure, the resistance of the conductive element changes. Thus, measuring the resistance of the strain gauge pressure sensor provides an indication of applied pressure.

Pressure sensors are often specified as having a certain operating range for pressures to which they will be exposed. End users will often specify which range they require when ordering a pressure sensor. Providing pressure sensors with extended operating ranges simplifies ordering and inventory requirements but can present challenges from a sensor design standpoint.

### SUMMARY

A pressure sensor includes a first wafer having a primary deflectable diaphragm and a secondary deflectable diaphragm. The primary deflectable diaphragm has a first relationship between applied pressure and deflection of the first deflectable diaphragm, and the second deflectable diaphragm has a second relationship between applied pressure and deflection of the second deflectable diaphragm. The first and second relationships differ from one another. A second wafer is attached to the first wafer. At least one tensile strain gauge is coupled to the primary deflectable diaphragm and at least one compressive strain gauge coupled to the secondary deflectable diaphragm. An overpressure feature is mounted relative to one of the first wafer and the second wafer. The overpressure feature is configured to contact the other of the first wafer and second wafer during an overpressure condition that exceeds a maximum measurement pressure of the primary deflectable diaphragm and a maximum measurement pressure of the secondary deflectable diaphragm. A pressure transmitter using the pressure sensor is also disclosed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view illustrating various tensile and compressive strain gauges on a square deflectable diaphragm of a silicon pressure sensor.

FIG. 2 is a diagrammatic cross-sectional view of a pressure sensor with an overpressure capability.

FIG. 3 is a finite element analysis plot comparing an existing narrow range pressure sensor to a pressure sensor where the overpressure protection engagement is beyond the extended range upper limit of 4 KSI.

FIG. 4 is a diagrammatic cross-sectional view of a high-output extended range pressure sensor in accordance with an embodiment of the present invention.

FIG. 5 is a bottom plan view of a device wafer of a pressure sensor in accordance with an embodiment of the present invention.

FIG. 6 is an FEA plot comparing strains at strain gauges of a pressure sensor in accordance with an embodiment described herein with and without a rectangular section.

FIG. 7 is a strain map of a pressure sensor in accordance with an embodiment of the present invention.

FIG. 8 is a diagrammatic view of maximum principal stresses for pressure sensors in accordance with embodiments described herein.

FIG. 9 is a diagrammatic view of maximum principal stress concentration at corners of an overpressure boss of a pressure sensor in accordance with an embodiment of the present invention.

FIG. 10A is a chart of gage factor versus pressure comparing the response of a known pressure sensor to a pressure sensor in accordance with an embodiment of the present invention.

FIG. 10B is an enlarged portion of a chart of gage factor versus pressure comparing the response of a known pressure sensor to a pressure sensor in accordance with an embodiment of the present invention.

FIG. 11 is a chart of sensor sensitivity versus pressure comparing sensitivity of a known pressure sensor to a pressure sensor in accordance with an embodiment of the present invention.

FIGS. 12A and 12B are diagrammatic finite element illustrations and a chart of maximum principal stress vs applied pressure, respectively, of a top film of a rectangular diaphragm during an overpressure event in accordance with an embodiment of the present invention.

FIGS. 13A and 13B are diagrammatic finite element illustrations and a chart of maximum principal stress vs applied pressure, respectively, of an unsupported bottom web of a rectangular diaphragm during an overpressure event in accordance with an embodiment of the present invention.

FIG. 14 is a bottom plan view of a device wafer of a strain gauge-based pressure sensor in accordance with another embodiment of the present invention.

FIG. 15 is a block diagram of a strain gauge-based pressure sensing system in accordance with an embodiment of the present invention.

FIG. 16 is a diagrammatic view of a pressure sensing system with which embodiments described herein are particularly useful.

### DETAILED DESCRIPTION OF ILLUSTRATIVE EMBODIMENTS

Embodiments described herein generally provide a multi-range inline pressure sensor. As used herein, an inline pressure sensor is a device that connects or otherwise couples directly to a process. In some embodiments, a pressure sensor is provided that can service multiple pressure ranges previously serviced by prior multiple sensors. In some embodiments, the pressure sensor includes overpressure protection that engages beyond the full extended measurement range. Additionally, some embodiments described herein include a rectangular stressed region within a sensing diaphragm, which is configured to amplify the compressive strain of the sensor, thus increasing its output.

Embodiments described herein are particularly suitable for strain gauge-based pressure sensor that use a crystalline deformable diaphragm. While embodiments will be described with respect to a silicon structure, it is expressly contemplated that other forms of crystalline structures can be used, including deformable diaphragms formed of other types of crystals or brittle material, such as alumina, sapphire, glass, and borosilicate glass.

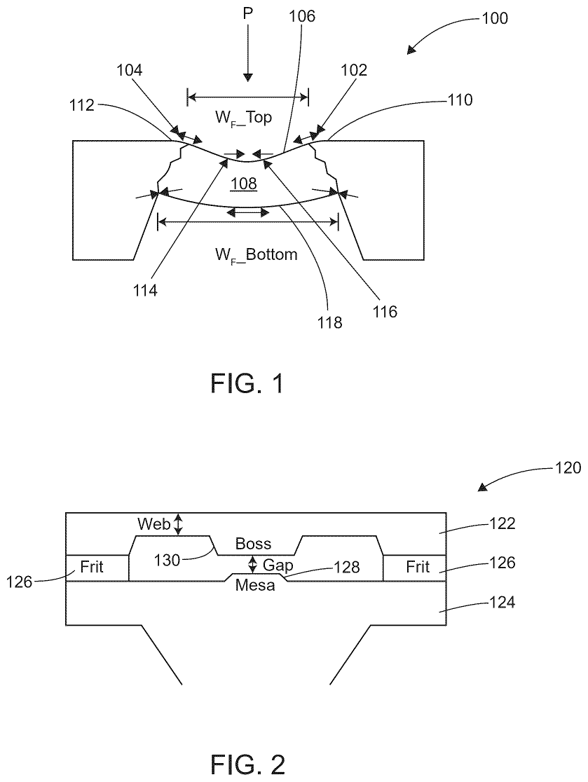

FIG. 1 is a diagrammatic view illustrating various tensile and compressive strain gauges on a square deflectable diaphragm of a silicon pressure sensor. When designing such a pressure sensor, there is a tradeoff between overpressure capability and sensor sensitivity. For a simple silicon pressure sensor, such as sensor 100 shown in FIG. 1, the strain gauges 102, 104 are typically located on the top side 106 of diaphragm 108. Strain gauges 102, 104 are tensile strain gauges located on the edges 110, 112, respectively, of diaphragm 108. Compressive strain gauges 114, 116 are located in the center of top side 106 of diaphragm 108. The electrical output of pressure sensor 100 is proportional to the difference in strain between tensile strain gauges 102, 104 and compressive strain gauges 114, 116. Typically, to increase the electrical sensitivity of the pressure sensor, diaphragm 108 is made more compliant. This is accomplished by increasing size, reducing thickness, or a combination of both. By doing this, the tensile and compressive strains increase. However, as diaphragm 108 becomes more compliant, it also becomes more fragile. This is due to silicon being a brittle material that will fracture under high tensile stress.

FIG. 2 is a diagrammatic cross-sectional view of a pressure sensor with an overpressure capability. Pressure sensor 120 is formed of a device wafer 122 coupled to a backing wafer 124 using glass frit 126. Pressure sensor 120 provides good sensor sensitivity and high overpressure capability for relatively narrow measurement ranges. The overpressure feature is in the form of cooperation between mesa 128 on backing wafer 124 and overpressure boss 130 on device wafer 122. Shortly after the pressure exceeds the upper range limit, overpressure boss 130 contacts mesa 128, limits any further deformation, and prevents device wafer 122 from breaking. While the arrangement shown in FIG. 2 is useful for narrower ranges, it is limited in extended range applications because the overpressure contact point is required to contact at a low pressure to prevent the diaphragm from breaking.

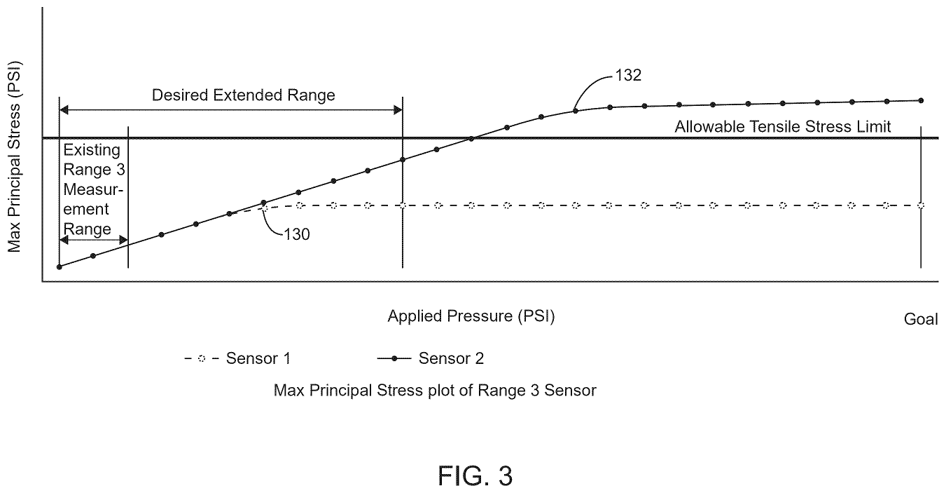

FIG. 3 is a finite element analysis plot comparing an existing narrow range pressure sensor to a pressure sensor where the overpressure protection engagement is beyond the extended range upper limit of 4 KSI. FIG. 3 shows a first sensor, denoted by a line with different shapes shown in FIG. 3, as having an overpressure engagement point 130 at which one or more overpressure stops engage and further changes in pressure cannot be reliably detected. A second sensor, denoted by a line with o's, has an overpressure engagement point 132 that is higher than the first sensor, but still inadequate for a 10 KSI sensor. As can be seen, if a 10 KSI overpressure sensor is desired, the stress levels must be reduced by making the diaphragm stiffer or introducing an overpressure stop. However, this results in a reduction of sensor sensitivity (for a stiffer diaphragm) or a reduction in the useful range of the sensor (if overpressure stops are added). Thus, there are a trade-offs between high overpressure capability, a large useful range, and adequate sensor sensitivity.

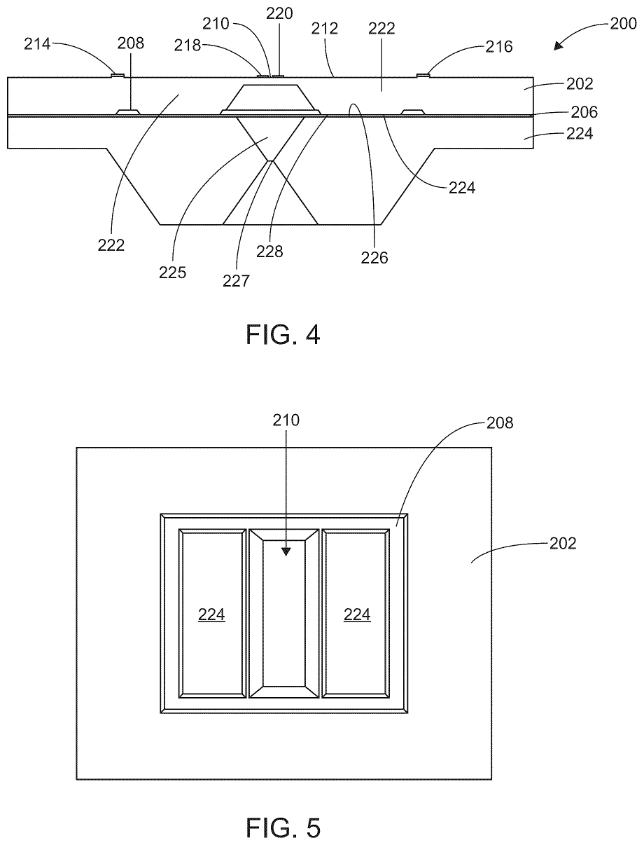

FIG. 4 is a diagrammatic cross-sectional view of a high-output extended range pressure sensor in accordance with an embodiment of the present invention. Pressure sensor 200 includes a device wafer 202 bonded to a backing wafer 204 using glass frit 206. The glass frit 206 may be disposed in a recess of device wafer 202, backing wafer 204 or both in order to ensure that the distance between distal surface 224 and contact surface 226 is set by direct contact between the wafers and not by the thickness and/or deformation of glass frit 206 during the bonding process. Pressure sensor includes a primary diaphragm 208 and a secondary diaphragm 210.

Backing wafer 204 may include a chamber 225, which may be formed by etching. Chamber 225 may be sealed and subjected to a vacuum during manufacture of pressure sensor 200 in order to render pressure sensor 200 an absolute pressure sensor. In other embodiments, backing wafer 204 may include an aperture 227 that allows chamber 225 to be at a reference pressure, such as atmospheric pressure, thereby rendering pressure sensor 200 a gage pressure sensor.

Primary diaphragm 208 has a different size and thickness than secondary diaphragm 210 and thus diaphragms 208, 210 react differently to pressure applied on surface 212 of device wafer 202. As shown in FIG. 4, a pair tensile strain gauges 214, 216 is positioned proximate an edge (outer edge in the illustrated example) of primary diaphragm 208. Additionally, a pair of compressive strain gauges 218, 220 is positioned proximate the center of secondary diaphragm 210. Combining signals from tensile strain gauges 214, 216 and compressive strain gauges 218, 220 provides pressure information over an extended range of operating pressures.

Pressure sensor 200 includes an overpressure protection feature in the form of overpressure bosses 222. Overpressure bosses 222, in the illustrated embodiment, extend from device wafer 202 toward backing wafer 204 but have a distal surface 224 spaced apart from surface 226 of backing wafer 204 by a precision gap 228. Under an overpressure condition, such as 10% above the maximum operating pressure, device wafer 202 will flex sufficiently to allow distal surface 224 to contact surface 226 of backing wafer thus preventing further deflection.

FIG. 5 is a bottom plan view of a device wafer of a pressure sensor in accordance with an embodiment of the present invention. As can be seen, primary diaphragm 208 is substantially square-shaped and surrounds secondary diaphragm 210. Each of diaphragms 208, 210 is preferably formed by etching. Overpressure bosses 222 are disposed within the perimeter of primary diaphragm 208 on either side of secondary diaphragm 210.

In operation, sensor sensitivity is directly related to the difference in tensile strain and compressive strain at the strain gauges. However, as described above, sensor robustness decreases with increasing tensile strain. Pressure sensors in accordance with embodiment described herein generally achieve high sensitivity and robustness by incorporating a thin rectangular section within the diaphragm, which amplifies only the compressive strain. The allows the diaphragm thickness to be increased, which results in the diaphragm being able to survive much higher overpressure without sacrificing sensor sensitivity.

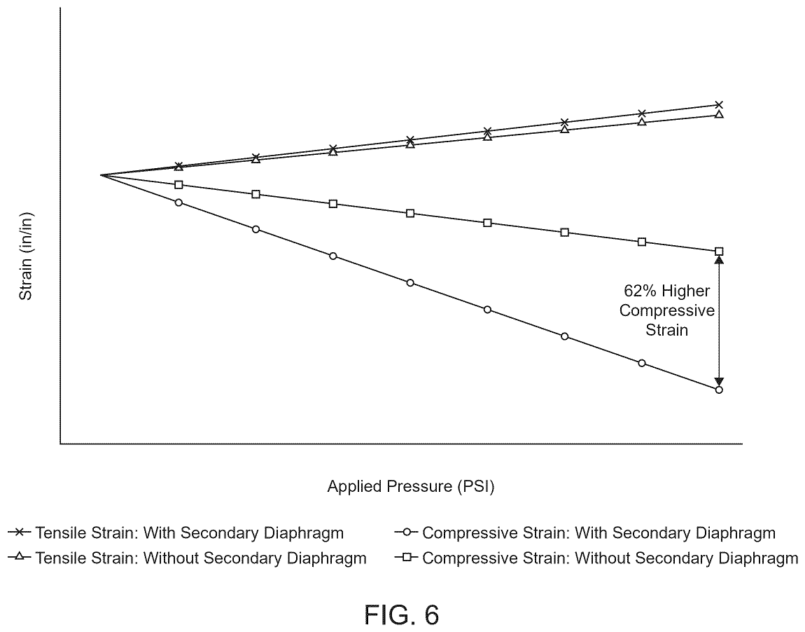

FIG. 6 is an FEA plot comparing strains at strain gauges of a pressure sensor in accordance with an embodiment described herein with and without a rectangular section. As can be seen, the thin rectangular section increases the compressive strain by 62%.

FIG. 7 is a strain map of a pressure sensor in accordance with an embodiment of the present invention. The rectangular shape of secondary diaphragm 210 (shown in FIG. 4) was selected for a number of reasons. First, the rectangular shape helps maximize the strained area for the strain gauges 214, 216, 218, and 220. The rectangular shape increases the area of maximum strain, thus increasing the average strain across the strain gauge. FIG. 7 shows where the strain gauges 214, 216, 218, and 220 are located.

FIG. 8 is a diagrammatic view of maximum principal stresses for pressure sensors in accordance with embodiments described herein. FIG. 8 shows corners of secondary diaphragm 210, which act as stress concentrations. These stresses are significantly minimized by moving the corners away from the higher tensile stress region of primary diaphragm 208. Additionally, making the secondary diaphragm rectangular minimizes bending of the unsupported section, further increasing overpressure capability.

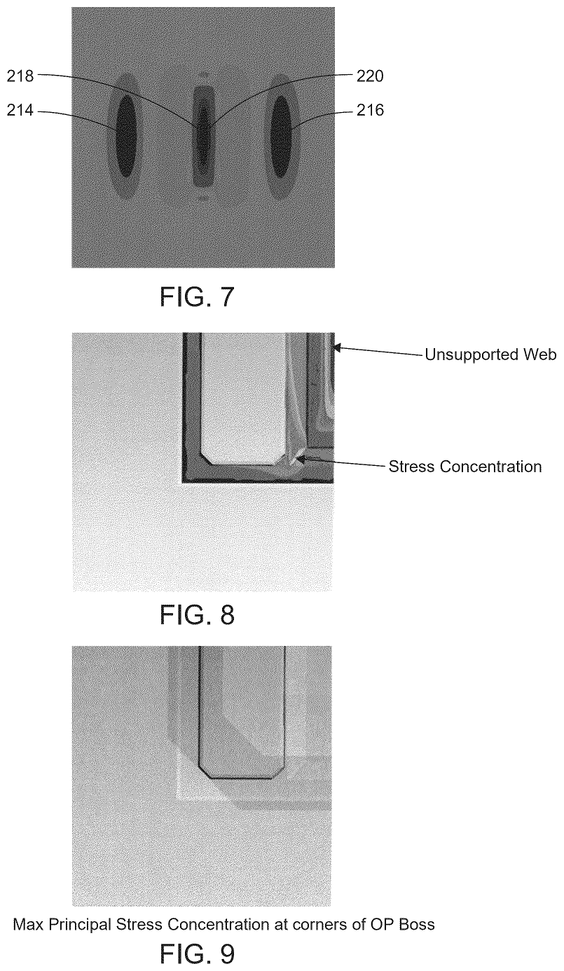

FIG. 9 is a diagrammatic view of maximum principal stress concentration at corners of an overpressure boss of a pressure sensor in accordance with an embodiment of the present invention. The illustrated overpressure boss design helps ensure that the primary diaphragm is fully supported during an overpressure event. Additionally, it is important to ensure that the stress concentrations at the corners of the overpressure stops are kept out of the area of high tensile stresses, thus reducing the maximum stress magnitude.

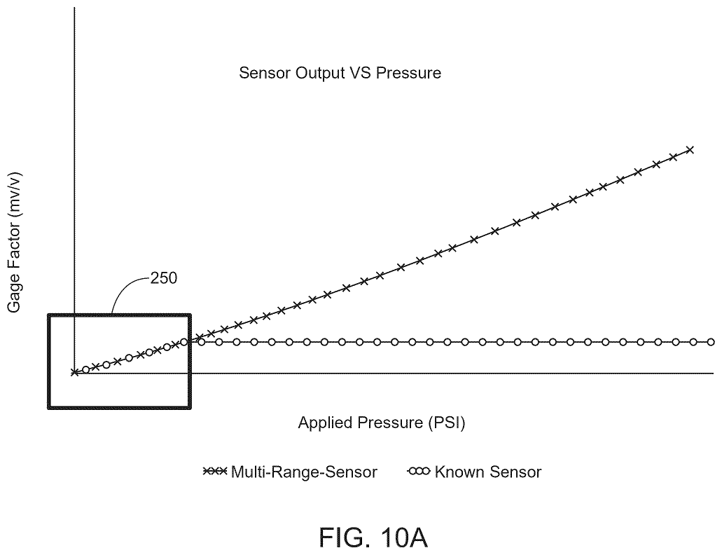

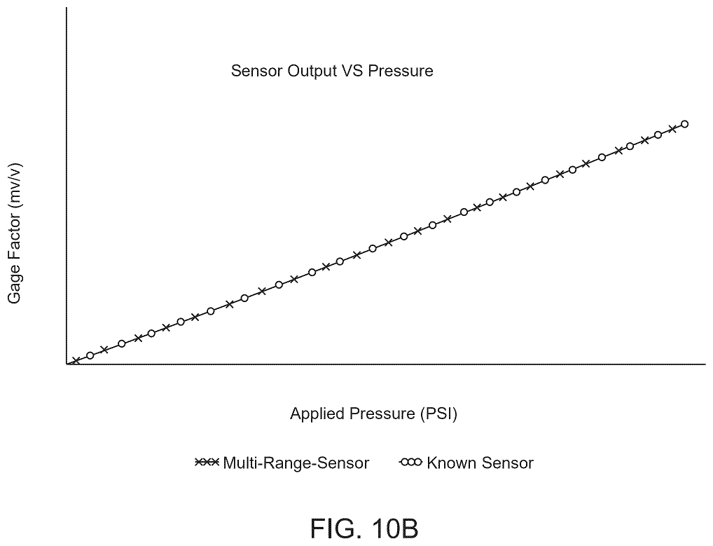

FIG. 10A is a chart of gage factor versus pressure comparing the response of a known pressure sensor to a pressure sensor in accordance with an embodiment of the present invention. FIG. 10B is an enlarged portion of box 250 (shown in FIG. 10A) of a chart of gage factor versus pressure comparing the response of a known pressure sensor to a pressure sensor in accordance with an embodiment of the present invention. As can be seen in FIG. 10A, the line of the known pressure sensor (denoted by lowercase o's on the line) substantially overlaps that of the pressure sensor in accordance with an embodiment of the present invention (labelled “Multi-Range sensor and denoted by lowercase x's on the line) in the pressure range of 0-800 psi. This overlap is shown in greater detail in FIG. 10B. However, as the pressure increases from 800 psi up to 4 KSI, the “Multi-Range Sensor” line continues substantially linearly, while the known sensor line turns horizontal as the overpressure stops engage.

It is believed that at least some embodiments described herein can be used as drop-in replacements for current narrower-range pressure sensors because it has a similar output characteristic. However, since the overpressure features of the “Multi-Range Sensor” do not activate until a pressure greater than 4 KSI, such a sensor could be used as a higher range sensor too, such as a 4000-psi upper sensor limit. The ability of this sensor to work equally well as a lower range sensor (0-800 psi) and as a higher range sensor (0-4000 psi) is why it is shown as a “multi-range sensor” in FIGS. 10A and 10B.

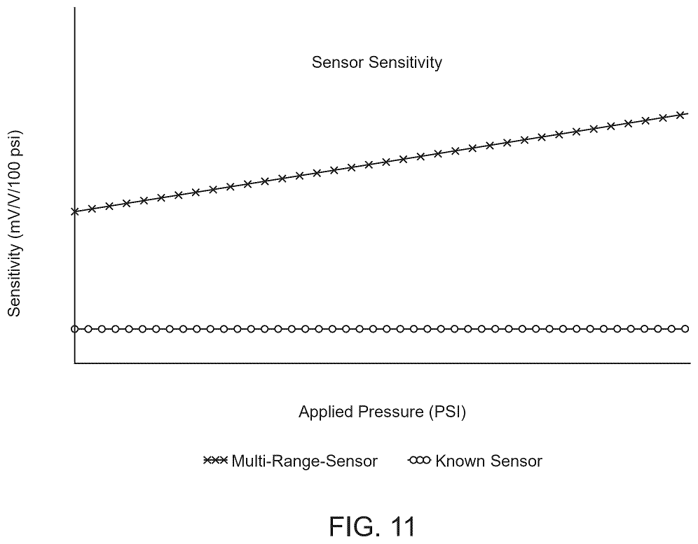

FIG. 11 is a chart of sensor sensitivity versus pressure comparing sensitivity of a known pressure sensor to a pressure sensor in accordance with an embodiment of the present invention. The line denoted by lowercase o's depicts sensitivity vs pressure of a known 0-4000 psi range pressure sensor. The line denoted by lowercase x's depicts sensitivity vs pressure of a pressure sensor in accordance with an embodiment of the present invention. As can be seen, the sensitivity of the new pressure sensor is approximately 60% higher at 4000 psi than it is at 100 psi, making it a very good sensor for high pressure application. The output of the new sensor is relatively smooth and has no abrupt changes, which means that it can be accurately characterized and fit with a suitable polynomial curve fit, such as a polynomial curve fit.

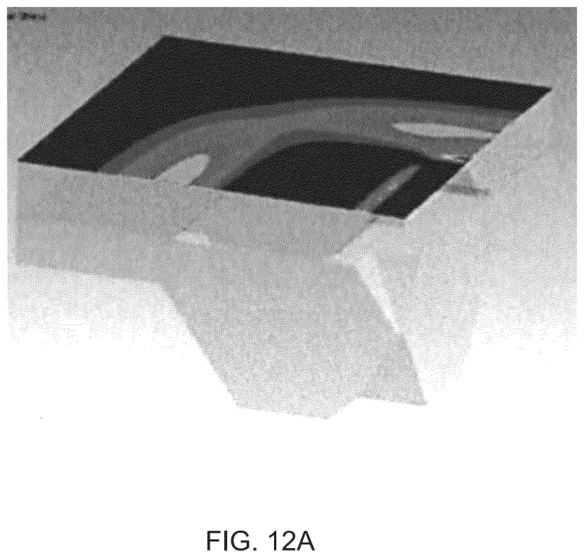

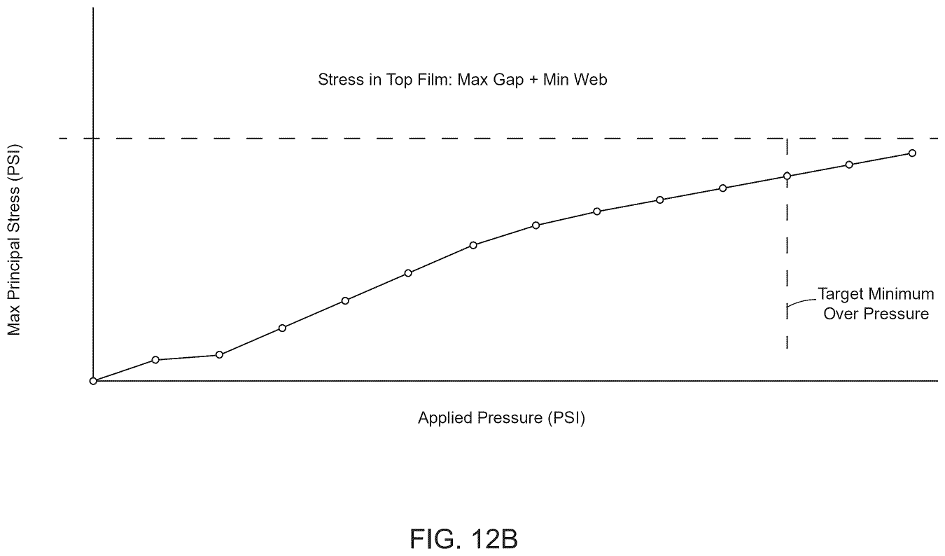

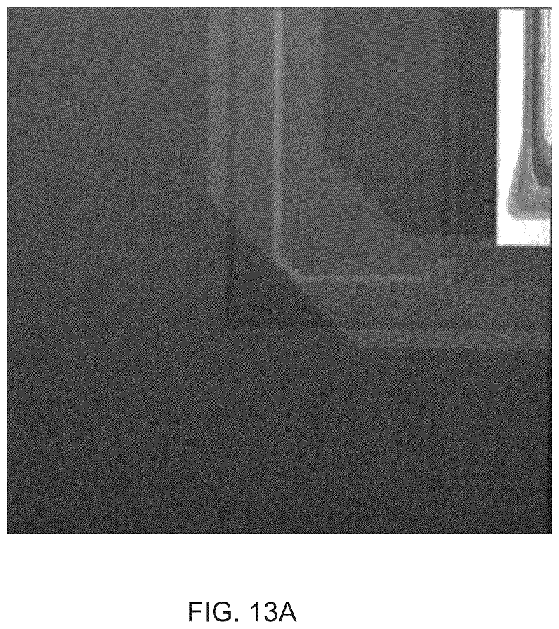

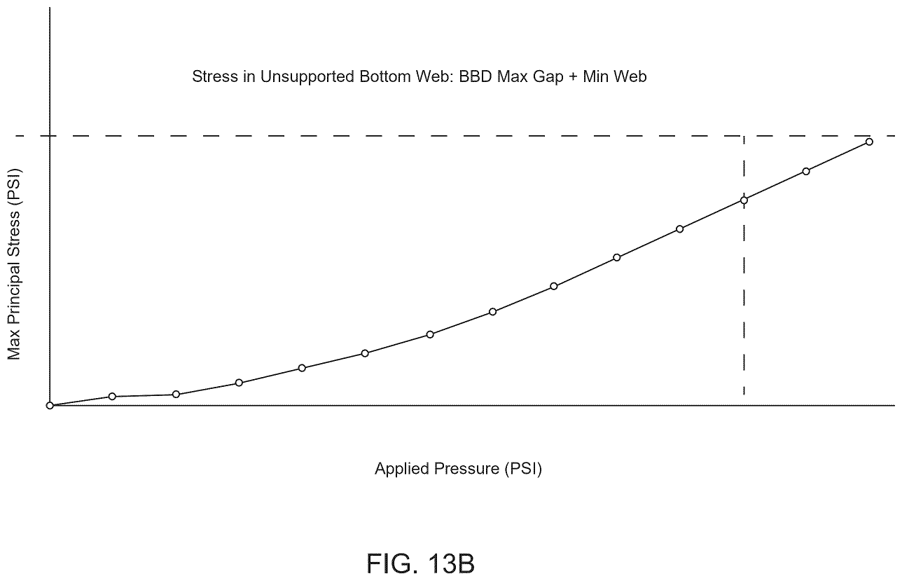

FIGS. 12A and 12B are diagrammatic finite element illustrations and a chart of maximum principal stress vs applied pressure of a top film, respectively, of a rectangular diaphragm during an overpressure event in accordance with an embodiment of the present invention. FIGS. 13A and 13B are diagrammatic finite element illustrations and a chart of maximum principal stress vs applied pressure, respectively, of an unsupported bottom web of a rectangular diaphragm during an overpressure event in accordance with an embodiment of the present invention. It should be noted that peak stress occurs in the etched-side of the thin rectangular section. This is desirable, as the failure mode is expected to be sudden and catastrophic, rather than exhibiting drift that can be mistaken for process drift prior to the sensor breaking.

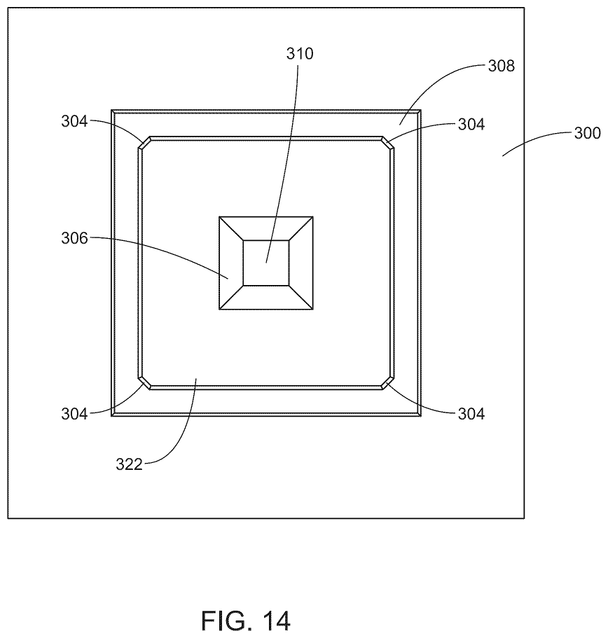

FIG. 14 is a bottom plan view of a device wafer of a strain gauge-based pressure sensor in accordance with another embodiment of the present invention. Device wafer 300 is preferably formed of silicon and bonded to a backing wafer, such as backing wafer 204 (shown in FIG. 4) using a glass frit. Device wafer 300 bears some similarities to device wafer 202 (shown in FIG. 4) and like components are numbered similarly. Device wafer 300 includes a primary diaphragm 308 that is illustrated have a square shape that surrounds a single overpressure boss 322. Additionally, both overpressure boss 322 and primary diaphragm 308 surround square-shaped secondary diaphragm 310. Overpressure boss 322 can include tapered corners 304 as shown. Additionally, the transition 306 from overpressure boss 322 to secondary diaphragm 310 can be tapered as well. The tapers shown in FIG. 14 help reduce stress concentrations.

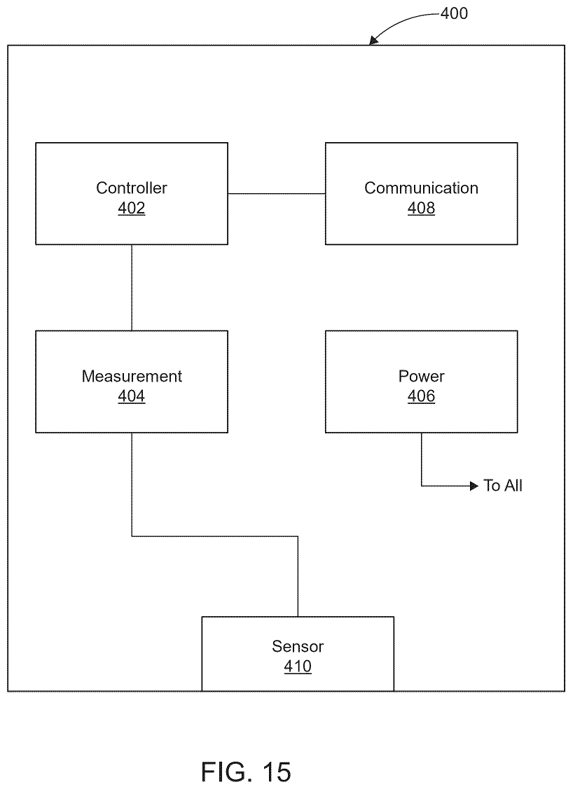

FIG. 15 is a block diagram of a pressure sensing system with which embodiments described herein are particularly useful. Transmitter electronics 400 includes controller 402, communication module 408, measurement circuitry 404 and power module 406. As shown in FIG. 15, measurement circuitry 404 is coupled to strain gauges on pressure sensor 410, which may be pressure sensor 200 (shown in FIG. 4) or a pressure sensor employing device wafer 300 (shown in FIG. 14).

Controller 402 may be any suitable circuitry that is able to execute a number of programmatic steps or functions to communicate with an external device using communication module 408. Controller 402 may be an application specific integrated circuit (ASIC), field programmable gate array (FPGA), microcontroller, or microprocessor.

Communication module 408 is configured to interact with controller 200 and to communicate in accordance with one or more standard protocols. The standard protocol may be a wired communication protocol, such as HART, 4-20 mA, FOUNDATION™ Fieldbus, Profibus, Modbus, Ethernet, and Ethernet-APL. The standard protocol may be a wireless communication protocol. Examples of wireless communication protocols include, without limitation, WirelessHART (IEC 62591), Cellular (NB-IoT, LTE-M), Wi-Fi, LoRaWAN, and Bluetooth Low Energy.

Transmitter electronics 400 includes power management circuitry 406 and provides regulated power to components of transmitter electronics 400. Additionally, power management circuitry 406 can also provide voltage monitoring for battery-operated assemblies.

As shown in FIG. 15, transmitter electronics 400 includes measurement circuitry 404 coupled to controller 402. Measurement circuitry 204 includes suitable circuitry for measuring an analog electrical characteristic (e.g., resistance) of one or more strain gauges on pressure sensor 410 and providing a digital indication of the measured analog electrical characteristic to controller 402. Suitable examples of circuitry of measurement processing circuitry includes one or more analog-to-digital converters, one or more amplifiers, and or one or more multiplexers or switches.

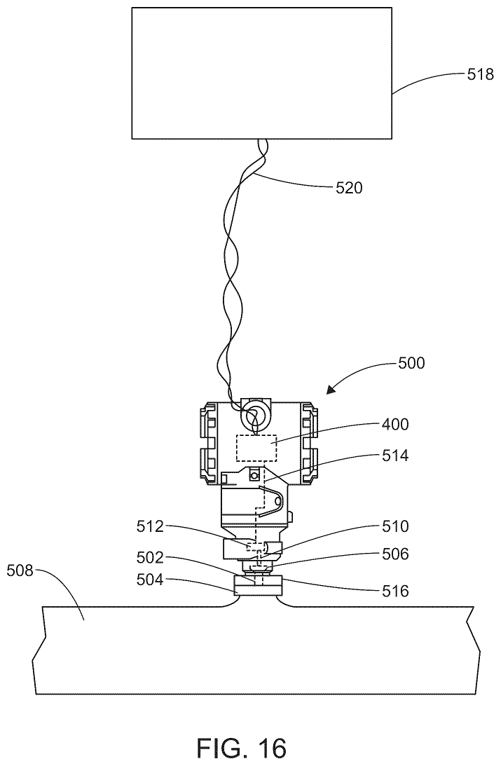

FIG. 16 is a diagrammatic view of a pressure sensing system with which embodiments described herein are particularly useful. In FIG. 16, a process variable transmitter 500 is mounted to a process coupling 504 of a pipe section 508 by a mounting member 516.

Mounting member 500 includes bore 502 which extends from process coupling 504 to an isolation diaphragm assembly 506. Isolation diaphragm assembly 506 includes an isolation diaphragm that isolates the process fluid in pipe section 508 from isolation fluid carried in an isolation capillary 510. Isolation capillary 510 couples to a pressure sensor 512, which takes the form of pressure sensor 100 described above. Pressure sensor 512 is configured to measure an absolute pressure (relative to vacuum) or a gage pressure (relative to atmospheric pressure) and provide an electrical output 514 to transmitter circuitry 400.

Transmitter circuitry 400 communicates with control room 518 to provide one or more process variables to control room 518, such as absolute pressure and gage pressure. Transmitter circuitry 400 may communicate with control room 518 using various techniques including both wired and wireless communication. One common wired communication technique uses what is known as a two-wire process control loop 520 in which a single pair of wires is used to carry information as well as provide power to transmitter 500. One technique for transmitting information is by controlling the current level through process control loop 520 between 4 milliamps and 20 milliamps. The value of the current within the 4-20 milliamp range can be mapped to corresponding values of the process variable.

Although the present invention has been described with reference to preferred embodiments, workers skilled in the art will recognize that changes may be made in form and detail without departing from the spirit and scope of the invention.

What is claimed IS:

1. A pressure sensor comprising:
a first wafer having a primary deflectable diaphragm and a secondary deflectable diaphragm, wherein the primary deflectable diaphragm has a first relationship between applied pressure and deflection of the first deflectable diaphragm, and the second deflectable diaphragm has a second relationship between applied pressure and deflection of the second deflectable diaphragm, wherein the first and second relationships differ from one another;
a second wafer attached to the first wafer;
at least one tensile strain gauge coupled to the primary deflectable diaphragm;
at least one compressive strain gauge coupled to the secondary deflectable diaphragm; and
an overpressure feature mounted relative to one of the first wafer and the second wafer, the overpressure feature being configured to contact the other of the first wafer and second wafer during an overpressure condition that exceeds a maximum measurement pressure of the primary deflectable diaphragm and a maximum measurement pressure of the secondary deflectable diaphragm.

2. The pressure sensor of claim 1, wherein the overpressure feature is mounted to the first wafer.

3. The pressure sensor of claim 1, wherein the overpressure feature includes a plurality of overpressure bosses disposed on opposite sides of the secondary deflectable diaphragm.

4. The pressure sensor of claim 1, wherein the first and second wafers are formed of silicon.

5. The pressure sensor of claim 4, wherein the first and second silicon wafers are attached to each other by glass frit disposed in a recess.

6. The pressure sensor of claim 1, wherein the primary deflectable diaphragm surrounds the overpressure feature.

7. The pressure sensor of claim 1, wherein the primary deflectable diaphragm surrounds the secondary deflectable diaphragm.

8. The pressure sensor of claim 7, wherein the secondary deflectable diaphragm is rectangularly-shaped.

9. The pressure sensor of claim 7, wherein the secondary deflectable diaphragm is square-shaped.

10. The pressure sensor of claim 1, wherein the at least one tensile strain gauge includes a plurality of tensile strain gauges.

11. The pressure sensor of claim 10, wherein the at least one compressive strain gauge includes a plurality of compressive strain gauges.

12. The pressure sensor of claim 1, wherein the at least one compressive strain gauge includes a plurality of compressive strain gauges disposed near a center of the secondary deflectable diaphragm.

13. The pressure sensor of claim 1, wherein the pressure sensor is an absolute pressure sensor.

14. The pressure sensor of claim 1, wherein the pressure sensor is a gage pressure sensor.

15. A pressure transmitter comprising:
transmitter circuitry configured to measure an electrical characteristic of a pressure sensor and provide a process fluid pressure output; and
a pressure sensor operably coupled to the transmitter circuitry, the pressure sensor including:
a first wafer having a primary deflectable diaphragm and a secondary deflectable diaphragm, wherein the primary deflectable diaphragm has a first relationship between applied pressure and deflection of the first deflectable diaphragm, and the second deflectable diaphragm has a second relationship between applied pressure and deflection of the second deflectable diaphragm, wherein the first and second relationships differ from one another;
a second wafer attached to the first wafer;
at least one tensile strain gauge coupled to the primary deflectable diaphragm;
at least one compressive strain gauge coupled to the secondary deflectable diaphragm; and
an overpressure feature mounted relative to one of the first wafer and the second wafer, the overpressure feature being configured to contact the other of the first wafer and second wafer during an overpressure condition that exceeds a maximum measurement pressure of the primary deflectable diaphragm and a maximum measurement pressure of the secondary deflectable diaphragm.

16. The pressure transmitter of claim 15, wherein the transmitter circuitry includes measurement circuitry coupled to the pressure sensor, the measurement circuitry being configured to measure a resistance of the at least one tensile strain gauge and a resistance of the at least one compressive strain gauge.

17. The pressure transmitter of claim 16, wherein the measurement circuitry is configured to measure a resistance of a plurality of tensile strain gauges and a plurality of compressive strain gauges.

18. The pressure transmitter of claim 17, wherein the transmitter circuitry is configured to apply a curve fit to the measured resistances to generate a process pressure output.

19. The pressure transmitter of claim 18, wherein the curve fit is a polynomial.

20. The pressure transmitter of claim 15, wherein the pressure sensor has a sensitivity that increases with pressure.
